(19) United States
(12) Patent Application Publication
(10) Pub. No.: US 2026/0006459 A1
(43) Pub. Date: Jan. 1, 2026

(54) MANAGEMENT OF MULTIPLE WIRELESS NETWORK FUNCTIONS TO PROVIDE WIRELESS SERVICE

(71) Applicant: Charter Communications Operating, LLC, St. Louis, MO (US)

(72) Inventor: Pareshkumar Panchal, Highlands Ranch, CO (US)

(21) Appl. No.: 18/755,605

(22) Filed: Jun. 26, 2024

(51) Int. Cl. H04W 24/02

(52) U.S. Cl. CPC H04W 24/02

(57) ABSTRACT

A communication management resource as discussed herein receives a proposed first modification to a first configuration (settings) of a first wireless network function. The first wireless network function provides overlapping wireless service with respect to a second wireless network function. In furtherance of synchronizing operation of the first wireless network function and the second wireless network function, the communication management resource identifies a first parameter type associated with the proposed first modification. Based on the first parameter type, the communication management resource determines an impact of the proposed first modification to the second wireless network function.

### BACKGROUND

Conventional wireless technology has been used for many years to connect wireless devices such as phones, laptops, etc., to a landline network and other wireless networks. Today, such wireless networks support many different types of connection services such as voice communications, cell communications, high-speed data services, Wi-Fi™ connectivity, and so on.

Cellular networks typically include a land area that has been divided into so-called cellular regions. A single base station typically resides in each cell. Often, the base station is connected to a landline network and supports communication with one or more wireless subscribers operating in a region covered by the cell. Accordingly, a wireless subscriber operating a cell phone in the cell is able to communicate with or have access to a landline network and remote network via a wireless link between the subscriber and a base station.

Conventional long-range cellular networks sometimes do not have the ability to provide connectivity to users at every location in a geographical region. One reason for this shortcoming is the high cost associated with designing and subsequently implementing a long-range cell tower for every portion of a geographical region. In many instances, a cell tower providing long-range coverage requires a long-term financial commitment. In certain instances, because costs are so high, a service provider may not even install a cell tower because it is not a good investment.

One type of wireless network function is a so-called D-SON (Distributed-Self Organized Network) network. In general, the D-SON network implements a radio vendor's proprietary algorithms at the edge of the network elements or nodes. Because it is distributed, each node has its own decision-making process and is implemented independently. This architecture makes the change making process near-real time with lowest latency possible.

Another type of wireless network function is a so-called C-SON (Centralized-Self Organized Network) network. In general, a C-SON network is a centralized architecture of servers where the algorithms reside in the network management system or centralized server that manages all radios nodes/elements. It can consider the data from all nodes/elements in the network and provide network wide optimization of parameters, addressing faults and inconsistencies. It may be developed by third party vendors to create vendor agnostic network management architecture.

### BRIEF DESCRIPTION OF EXAMPLES

This disclosure includes the observation that both of the above mentioned networks (such as a D-SON network and a C-SON network) operate independently of each other, which creates a situation where a C-SON network may try to implement some parameter changes independent of the D-SON network. However, the D-SON network may have already implemented part of those parameters or related such parameters which were not considered when the C-SON network decided to implement the change.

More specifically, assume that the C-SON network is trying to update parameter name (cell individual offset from 2 dB to 4 dB between cell A to cell B relation) while the D-SON network has deleted the neighbor relation between cell A to cell B. There may be n-number of such instances where the related parameters are implemented by D-SON network, but the C-SON network is using the outdated parameter setting information due to the architecture of the applications. This may result in overall malfunctioning of the wireless network which can lead to inappropriate user experience or network performance.

In one case, the architecture of C-SON network may be deployed independent of the D-SON network, where algorithms of each of the networks are not aligned with each other. This results in poor wireless network performance when the C-SON network function and the D-SON network function provide wireless services in the same wireless region or controlling or managing similar or nearby nodes and network elements.

To provide better use of wireless resources in the network environment, techniques as discussed herein provide improved implementation of multiple networks residing in the same geographical region to provide wireless services to respective wireless communication devices.

More specifically, a communication management resource as discussed herein receives a proposed first modification to a first configuration (i.e., settings) of a first wireless network function; the first wireless network function provides overlapping wireless service with respect to a second wireless network function. The communication management resource identifies a first parameter type associated with the proposed first modification. Based on the first parameter type, the communication management resource determines an impact of the proposed first modification to the second wireless network function.

In one example, the first wireless network function is a first wireless network providing first wireless services via first resources; the second wireless network function is a second wireless network providing second wireless services via second resources.

In a further example as discussed herein, the determination of the impact of the proposed first modification to the second wireless network function may include the communication management resource mapping the first parameter type to one or more saying or different parameters associated with operation of the second wireless network function.

Yet further, the determination of the impact of the proposed first modification to the second wireless network function may include the communication management resource or other suitable entity mapping the first parameter type to the second parameter type, the second parameter type different than the first parameter type.

In accordance with a further example, the communication management resource can be configured to produce a two-dimensional table including a first array of parameter types and a second array of parameter types. In one example, the first array of parameter types pertains to the first wireless network function; wherein the second array of parameter types pertains to the second wireless network function. The operation of producing the two-dimensional table may include the communication management resource, for each parameter type in the first array, marking at least one parameter type in the second array.

Still further examples as discussed herein include the communication management resource detecting that the impact of the proposed first modification to the second wireless network function is greater than a threshold level. In response to detecting the condition that the impact is greater than a threshold, the communication management resource can be configured to prevent implementation of the proposed first modification in the first wireless network function.

Yet further examples as discussed herein include the communication management resource or other suitable entity providing notification to an operator of the first wireless network function to implement the proposed first modification in response to detecting that the impact of the proposed first modification to the second wireless network function is less than a threshold.

Another example as discussed herein includes the communication management resource providing notification of the proposed first modification to an operator of the second wireless network function in response to receiving the proposed first modification.

Still further examples as discussed herein include the communication management resource receiving the proposed first modification to the configuration of the first wireless network function from a communication management resource operative to manage implementation of the first wireless network function.

In one example, the first wireless network function is a D-SON (Distributed-Self Organizing Network) wireless network function; the second wireless network function is a C-SON (Centralized-Self Organizing Network) wireless network function.

Yet further examples as discussed herein include the communication management resource or other entity receiving a proposed second modification to a second configuration of the second wireless network function. The communication management resource identifies a second parameter type associated with a second modification as specified by the proposed second modification. Based on the second parameter type, the communication management resource determines an impact of the proposed second modification to the first wireless network function. Accordingly, the communication management resource or other suitable entity as discussed herein can be configured to analyze multiple proposed modifications to configuration of a second wireless network function to determine a respective impact of the proposed modifications. In one example, the communication management resource determines the impact wireless network functions to synchronize operation of the wireless network functions and provide more efficient use of wireless resources.

These and other examples are further discussed herein.

Note that the examples as discussed herein are useful over conventional techniques. For example, implementation of a communication management resource and corresponding operations as discussed herein provide more efficient deployment of overlapping wireless networks and corresponding wireless network functions improved wireless coverage to provide wireless connectivity to different users.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable hardware storage on which software instructions are encoded for subsequent execution. The computer-readable storage hardware for storing instructions may be configured as a non-transitory computer-readable storage medium. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer-readable storage hardware such as a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example herein includes computer-readable storage hardware and/or system having instructions stored thereon. The instructions, when executed by the computer processor hardware, cause the computer processor hardware (such as one or more co-located or disparately processor devices or hardware) to: receive a proposed first modification to a first configuration of a first wireless network function, the first wireless network function providing overlapping wireless service with respect to a second wireless network function; identify a first parameter type associated with the proposed first modification; and based on the first parameter type, determine an impact of the proposed first modification to the second wireless network function.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity via efficient implementation of wireless base stations in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment implementing communication management and synchronization amongst multiple networks as discussed herein.

FIG. 2 is an example diagram illustrating map information mapping parameters between a first wireless network function and a second wireless network function as discussed herein.

FIG. 3 is an example diagram illustrating wireless service overlap of a first wireless network function and a second wireless network function as discussed herein.

FIG. 4 is an example diagram illustrating use of the mapping information to manage synchronization of multiple different networks as discussed herein.

FIG. 5 is an example diagram illustrating execution of a relativity evaluation engine to manage implementation of proposed changes to a first wireless network function based on the determined impact to a second wireless network function as discussed herein.

FIG. 6 is an example diagram illustrating execution of a relativity evaluation engine to manage implementation of proposed changes to one or more networks as discussed herein.

FIG. 7 is an example diagram illustrating execution of a relativity evaluation engine to manage proposed changes to one or more wireless network functions as discussed herein.

FIG. 8 is an example diagram illustrating example computer hardware and software operable to execute operations as discussed herein.

FIG. 9 is an example diagram illustrating a method as discussed herein.

The foregoing and other objects, features, and advantages of the invention (as described in the following examples) will be apparent from the following more particular description of preferred implementations herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

In one example as discussed herein, a communication management resource receives a proposed first modification to a first configuration of a first wireless network function, the first wireless network function providing overlapping wireless service with respect to a second wireless network function. The communication management resource identifies a first parameter type associated with the proposed first modification. Based on the first parameter type, the communication management resource determines an impact of the proposed first modification to the second wireless network function.

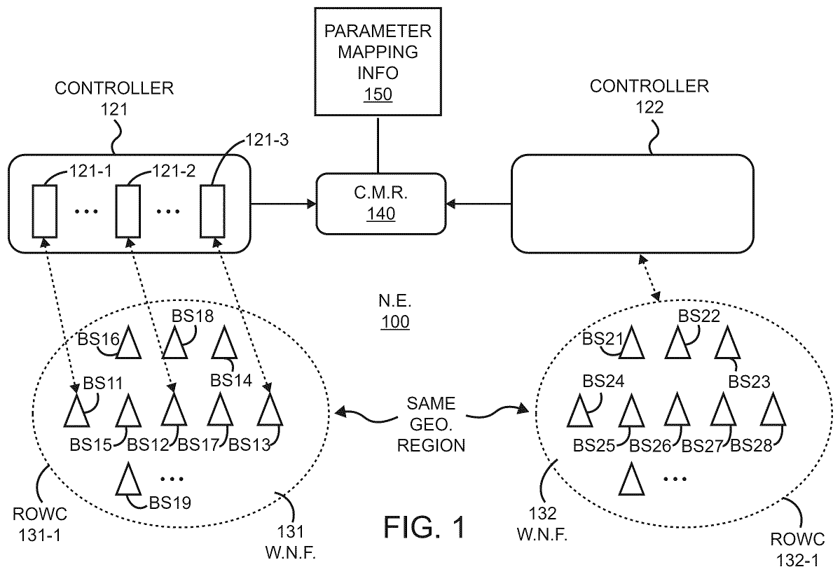

FIG. 1 is an example diagram illustrating a wireless network environment implementing communication management amongst multiple networks as discussed herein.

As shown in FIG. 1, the network environment 100 includes wireless network function controller 121, wireless network function controller 122, first wireless network function 131, second wireless network function 132, communication management resource 140, and parameter mapping information 150.

Wireless network function 131 (such as a first wireless network or a first portion of a wireless network) includes a station BS11, base station BS12, base station BS13, base station BS14, base station BS15, base station BS16, base station BS17, base station BS18, base station BS19, etc.

Wireless network function controller 121 includes multiple node controllers such as node controller 121-1, node controller 121-2, node controller 121-3, etc.

In one example, a single node controller associated with the wireless network function controller 121 controls operation of a respective wireless base station in the wireless network function 131. For example, node controller 121-1 controls operation/configuration of the base station BS11, node controller 121-2 controls operation and configuration of the base station BS12, node controller 121-3 controls operation and configuration of the base station BS13, and so on.

Accordingly, the wireless network function controller 121 is a distributed controller system in which each individual controller is responsible to configure a respective base station at the node level.

In contrast to the wireless network function controller 121, the wireless network function controller 122 (such as a single controller) is configured to manage the group of base stations including wireless base station BS21, wireless base station BS22, wireless base station BS23, wireless base station BS24, etc., at the network level.

Note that any of the resources as discussed herein can be configured as hardware, software, or a combination of hardware and software. For example, the node controller 121-1 can be configured as node controller hardware, node controller software, or a combination of node controller hardware and node controller software. The node controller 121-2 can be configured as node controller hardware, node controller software, or a combination of node controller hardware and node controller software. The node controller 121-3 can be configured as node controller hardware, node controller software, or a combination of node controller hardware and node controller software. Communication management resource 140 can be configured as communication management hardware, communication management software, or a combination of communication management hardware and communication management software. Wireless network function controller 122 can be configured as wireless network function controller hardware, wireless network function controller software, or a combination of wireless network function controller hardware and wireless network function controller software; and so on.

Note that in a given network, wireless network functions 121 and 122 could be managing more than one applications as a network management function, each application may be referring to similar, dependent, or independently referenced parameters and values. A relativity matrix as discussed herein can be extended as per the network configuration and management along with supported technology or technologies.

Note further that the wireless network function 131 and the wireless network function 132 can be implemented by single service provider. In such an instance, the combination of wireless network function 131 and wireless network function 132 collectively provide wireless connectivity to respective mobile communication devices. The techniques of synchronizing as discussed herein ensure that a respective first portion of the overall wireless network such as wireless network function 131 is appropriately and efficiently synchronized with the second portion of the overall wireless network such as wireless network 132.

Alternatively, the first wireless network function 131 may be implemented by a first wireless network service provider while the second wireless network function 132 may be implemented by a second wireless network service provider.

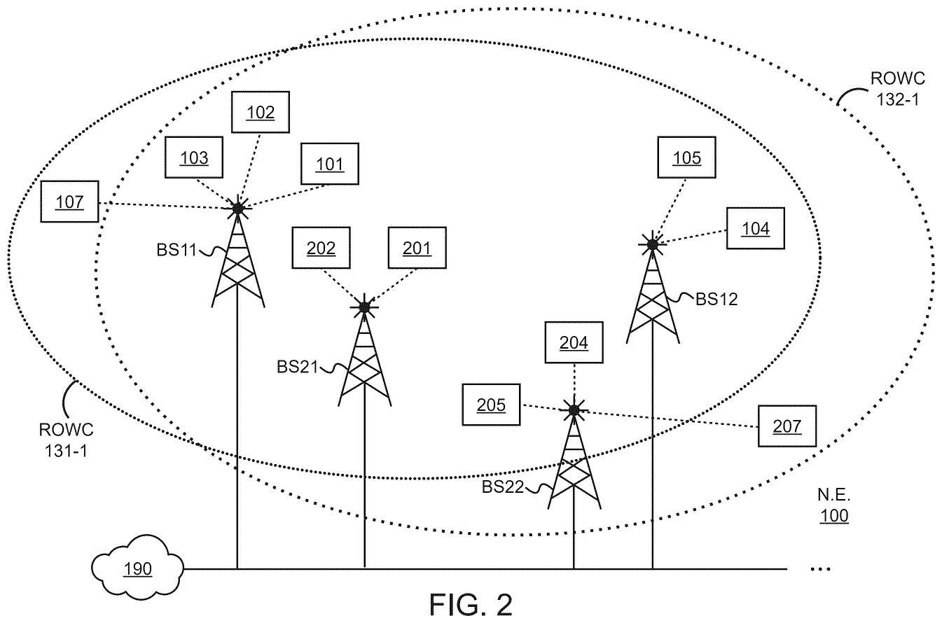

A more detailed example of implementing multiple overlapping wireless network functions is shown in FIG. 2.

FIG. 2 is an example diagram illustrating overlapping regions of wireless coverage by a first wireless network and a second wireless network as discussed herein.

In this example, the network environment 100 includes wireless network function 131 providing the region of wireless coverage 131-1 to multiple mobile communication devices as well as wireless network function 132 providing region of wireless coverage 132-1 to multiple mobile communication devices. The two regions of wireless coverage on are substantially overlapping if not completely overlapping.

It is noted that the region of wireless coverage 131-1 and the region of wireless coverage 132-1 substantially overlap each other. Accordingly, the mobile communication devices present in the overlap region where the region of wireless coverage 132-1 and the region of wireless coverage 131-1 overlap each other are able to access the remote network 190 via use of either the first wireless network function 131 or the second wireless network function 132 in circumstances where the respective indication device is a simultaneously subscriber to the first wireless network function 131 and a subscriber to the second wireless network function 132.

As further shown in FIG. 2, the wireless base station BS11 provides the mobile communication devices 101, 102, 103, 107, etc., access to the network 190 via communications through the wireless base station BS11; the wireless base station BS12 provides the mobile communication devices 104, 105, etc., access to the network 190 via communications through the wireless base station BS12, and so on.

The wireless base station BS21 provides the mobile communication devices 201, 202, etc., access to the network 190 via communications through the wireless base station BS21; the wireless base station BS22 provides the mobile communication devices 204, 205, 207, etc., access to the network 190 via communications through the wireless base station BS22, and so on.

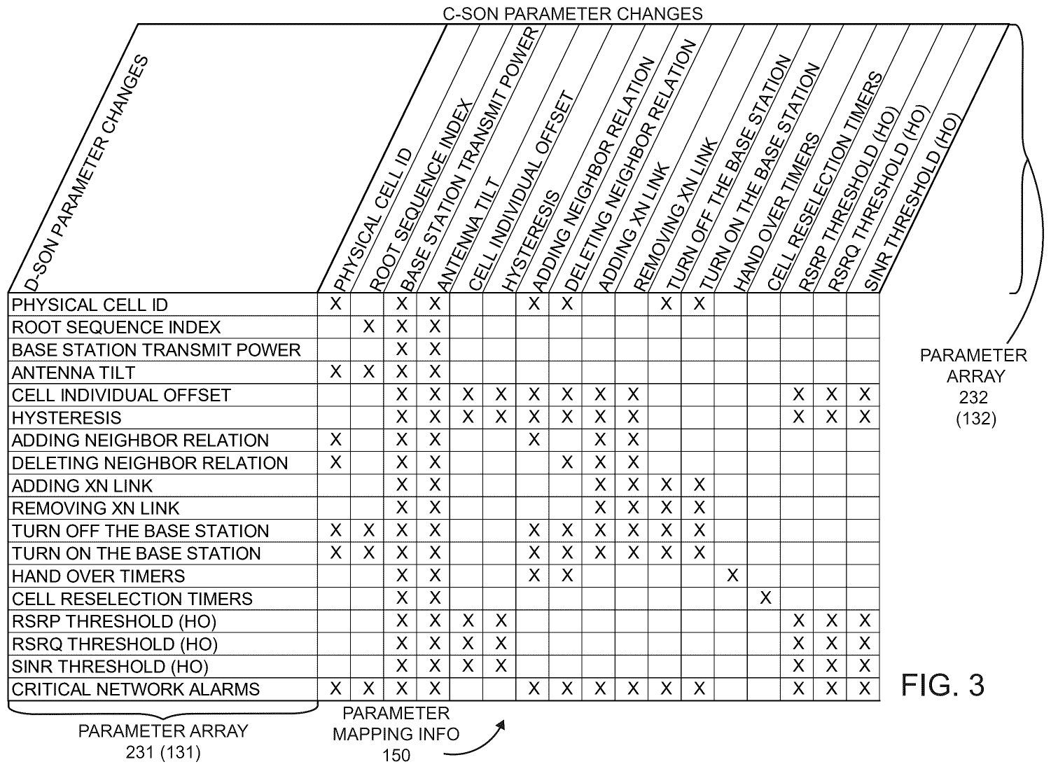

An example of the parameter mapping information 150 is shown in FIG. 3.

FIG. 3 is an example diagram illustrating overlap of a first wireless network function and a second wireless network function as discussed herein.

In this example, the map information 150 is implemented as a multidimensional array including a first parameter array 231 associated with the wireless network function 131 and corresponding wireless base stations as well as a second parameter array 232 associated with the wireless network function 132 and corresponding wireless base stations.

Note that the array of parameters can include any suitable types. For example, the parameter array 231 associated with the wireless network function 131 includes multiple parameters such as physical cell ID (Identifier), root sequence index, base station transmitting power, antenna tilt, cellular individual offset, hysteresis, adding neighbor relations, deleting the neighbor relations, adding Xn link, removing Xn link, turn off base station, turn on base station, hand over timers, cellular selection timers, RSRP (Reference Signal Receive Power) threshold for handoffs, RSRQ (Reference Signal Received Quality) threshold for handoffs, SINR (Signal-to-Interference-plus-Noise Ratio) threshold for handoffs, and critical network alarms.

The parameter array 232 associated with the wireless network function 132 includes multiple parameters such as physical cell ID (Identifier), root sequence index, base station transmitting power, antenna tilt, cellular individual offset, hysteresis, adding neighbor relations, deleting the neighbor relations, adding Xn link, removing Xn link, turn off base station, turn on base station, hand over timers, cellular selection timers, RSRP (Reference Signal Receive Power) threshold for handoffs, RSRQ (Reference Signal Received Quality) threshold for handoffs, SINR (Signal-to-Interference-plus-Noise Ratio) threshold for handoffs.

The parameter mapping information 150 indicates how a setting change in one parameter in one network effects settings of one or more parameters in another network.

For example, a first wireless network service provider (operator) controlling operation of the wireless network function 131 may propose to implement a change to one or more parameters as indicated in the parameter array 231. The map information 150 indicates which parameters in the second wireless network function 132 may be affected by the proposed changes to the first wireless network function 131. Via the use of the map information 150, the communication management resource as discussed herein identifies which parameters and corresponding settings in the network 132 that should be considered (evaluated) before allowing the first wireless network function 131 to implement the proposed change. As further discussed herein, this evaluation and checking process ensures that the settings of each of the wireless network function 131 and wireless network function 132 are selected such that the networks provide best use of available wireless resources.

More specifically, as indicated by the map information 150, a proposed configuration change to a physical cell identifier in the first network 131 (see first entry and corresponding row in the parameter array 231) may have an effect on multiple settings of parameters in the second wireless network function 132 including settings of the physical cell identifier, base station transmit power, antenna tilt, adding neighbor relation, the leading neighbor relation, turn on the base station, turn off the base station.

Additionally, as indicated by the map information 150, a proposed configuration change to a physical cell identifier in the wireless network function 132 (see first entry and corresponding column in the parameter array 232) may have an effect on multiple parameters in the first wireless network function 131 including settings of parameters including physical cell identifier, antenna tilt, adding neighbor relation, deleting neighbor relation, turn on the base station, turn off the base station, and critical network alarms.

As indicated by the map information 150, a proposed configuration change of a particular parameter type such as an implemented root sequence index in the first network 131 (see second entry and corresponding row in the parameter array 231) may have an effect on multiple parameters in the second wireless network function 132 including root sequence index, base station transmit power, and antenna tilt.

Additionally, as indicated by the parameter mapping information 150, a proposed configuration/setting change to a parameter such as root sequence index in the wireless network function 132 (see second entry and corresponding column in the parameter array 232) may have an effect on settings of multiple parameters in the first wireless network function 131 including root sequence index, antenna tilt, turn off a base station, turn on a base station, and critical network alarms.

As indicated by the parameter mapping information 150, a proposed configuration change to an implemented base station transmit power to the first wireless network function 131 (see third entry and corresponding row in the parameter array 231) may have an effect on multiple parameters in the second wireless network function 132 including base station transmit power and antenna tilt in the second wireless network function 132.

Additionally, as indicated by the map information 150, a proposed configuration change to a base station transmit power in the wireless network function 132 (see third entry and corresponding column in the parameter array 232) may have an effect on multiple parameters in the first wireless network function 131 including physical cell ID, root sequence index, base station transmitting power, antenna tilt, cellular individual offset, hysteresis, adding neighbor relations, deleting neighbor releasing, adding Xn link, removing Xn link, turn off base station, turn on base station, hand over times, cellular reselection timers, RSRP (Reference Signal Receive Power) threshold for handoffs, RSRQ (Reference Signal Received Quality) threshold for handoffs, SINR (Signal-to-Interference-plus-Noise Ratio) threshold for handoffs, critical network alarms

Thus, as illustrated above and as shown by the map information 150, because the wireless network function 131 and the wireless network function 132 present in the network environment 100 operates in a different manner (wireless network function 131 is potentially a D-SON network and wireless network function 132 is potentially a C-SON network), the map information is asymmetrical. For example, as previously discussed, a change in a root sequence index implemented in the wireless network function 131 has a potential effect on a first set of parameter settings in the second wireless network function 132; a change in a root sequence index implemented in the second wireless network function 132 has a potential effect on a second set of parameter settings in the first wireless network function 131. Because the map information 100 is asymmetrical, the first set of parameter settings and the second set of parameters settings of different for the parameter root sequence index.

Thus, the communication management resource 140 or other suitable entity can be configured to produce a two-dimensional table (such as map information 150) including a first parameter array 231 of parameter types and a second parameter array 232 of parameter types. As previously discussed, the first array 231 of parameter types pertains to the first wireless network function 131. The second array 232 of parameter types pertains to the second wireless network function 132.

When the map information 150 is produced, the communication management resource 140 can be configured to mark at least one parameter type in the second array 232 for each parameter type in the first array 231.

Referring again to FIG. 1, as further discussed herein, the communication management resource 140 uses the map information 150 as a basis in which to manage/synchronize operations of the multiple networks including wireless network function 131 and wireless network function 132. Synchronization of the multiple overlapping networks in the network environment 100 provides more efficient utilization of respective available wireless resources such as wireless channels.

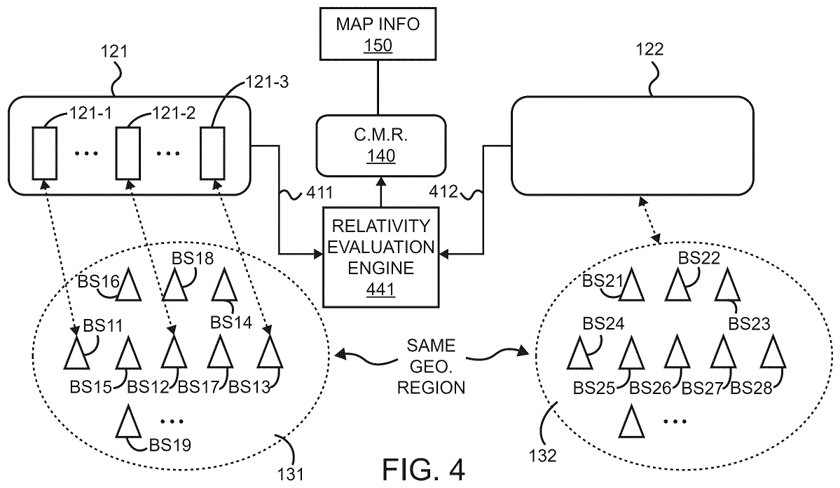

FIG. 4 is an example diagram illustrating use of the mapping information to manage synchronization of multiple different networks as discussed herein.

In this example, the communication management resource 140 (such as an element management system or other suitable entity) implements a relativity evaluation engine 441 to receive proposed changes to either or both of the wireless network function 131 and 132. As previously discussed, the relativity evaluation engine 441 or communication management resource 140 uses the map information 150 as a basis in which to determine how a proposed change to one network potentially effects settings of the other wireless network function.

As further shown, the relativity evaluation engine 441 can be configured to receive the proposed changes to the wireless network function 131 via communications 411 transmitted from the wireless network function controller 121 to the relativity evaluation engine 441 associated with the communication management resource 140 (configuration management resource ensuring synchronization between the wireless network function 131 to the wireless network function 132). In a manner as previously discussed, the communication management resource 140 or the relativity evaluation engine 441 uses the map information 150 to determine which parameters and corresponding settings in the second wireless network function 132 need to be reviewed before allowing implementation of a respective proposed change in the first wireless network function.

Additionally, as further shown, the relativity evaluation engine 441 can be configured to receive the proposed changes to the wireless network function 132 via communications 412 transmitted from the wireless network function controller 122 or the suitable entity to the relativity evaluation engine 441 associated with the communication management resource 140 (configuration management resource ensuring synchronization between the wireless network function 132 to the wireless network function 131). In a manner as previously discussed, the communication management resource 140 or the relativity evaluation engine 441 uses the map information 150 to determine which parameters and corresponding settings in the first wireless network function 131 need to be reviewed before allowing implementation of a respective proposed change in the second wireless network function.

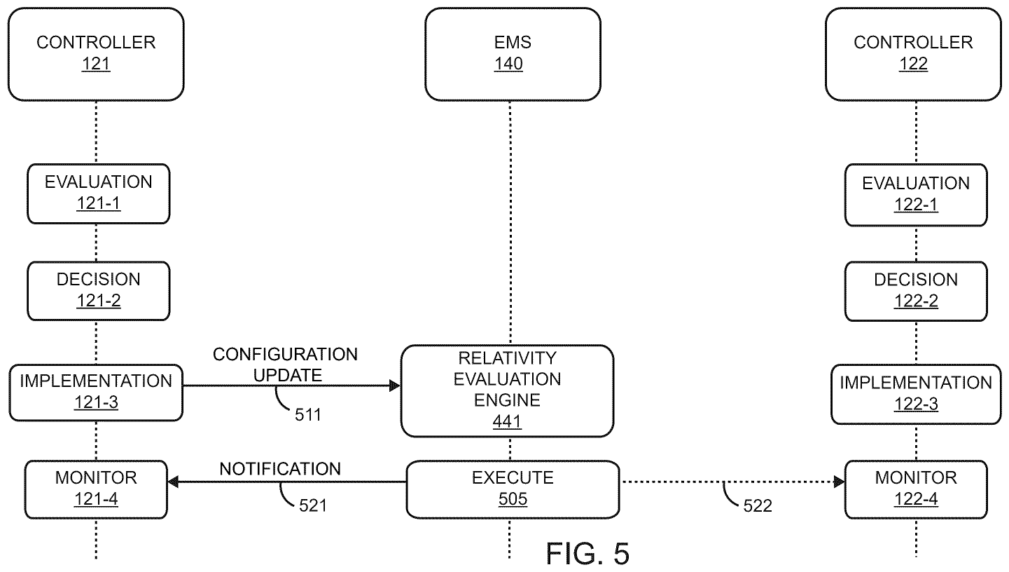

FIG. 5 is an example diagram illustrating execution of a relativity evaluation engine to manage implementation of proposed changes to a network as discussed herein.

As previously discussed, the first wireless network function 131 may be a D-SON (Distributed-Self Organizing Network) network or other type of wireless network function providing wireless services; the second wireless network function 132 may be a C-SON (Centralized-Self Organizing Network) network or other suitable type of network.

Also, as previously discussed, the differences between the first wireless network function 131 and the second wireless network function 132 results in an asymmetrical map information 150.

In this example, the wireless network function controller 121 implements one or more functions such as the evaluation function 121-1, decision function 121-2, implementation function 121-3, monitor function 121-4, etc.

In a similar manner, the wireless network function controller 122 implements one or more functions such as the evaluation function 122-1, decision function 122-2, implementation function 122-3, and the monitor auction 122-4.

Assume in this example that the wireless network function controller 121 receives or generates a corresponding proposed change to the implementation of the wireless network function 131. The change specifies a corresponding parameter associated with a setting to which the change pertains. As previously discussed, the change to the first wireless network function 131 and corresponding setting may impact the second wireless network function 132.

As its name suggests, the evaluation function 121-1 evaluates the respective first wireless network function 131 and/or a proposed change to the wireless network function 131.

As its name suggests, the decision function 121-2 decides whether or not to attempt the proposed change to the wireless network function 131.

Assuming that the decision function 121-2 decides to go forward with a proposed change to one or more parameters in corresponding settings associated with the wireless network function 131, the implementation function 121-3 transmits communications 511 to the relativity evaluation engine 441 associated with the communication management resource 140.

In one example, the communications 511 include an indication of the proposed changes (such as change in parameter settings, parameters relevant to the changes, etc.) to the wireless network function 131. The communications 511 further indicate which parameter settings of the wireless network function 131 are going to be changed.

Thus, in one example, via communications 511, the communication management resource 140 receives a proposed first modification to the configuration of the first wireless network function 131 from a communication management resource (such as wireless network function controller 121 and corresponding functions) operative to manage implementation of the first wireless network function 131.

Via receipt of the communications 511, the relativity evaluation engine 441 associated with communication management resource 140 is aware of the one or more parameters and corresponding settings that are requested to be changed by the wireless network function controller 121.

In a manner as previously discussed, the relativity evaluation engine 441 evaluates the proposed configuration changes to the one or more parameter settings by using the map information 150 to determine what parameter settings associated with the wireless network function 132 may be impacted by the proposed configuration changes indicated by the communications 511.

Note that the proposed changes as indicated by the communications 511 may or may not impact wireless network function 132.

As determined by the communication management resource 140, in a case where the proposed changes (such as adjustment to the root sequence index parameter and corresponding proposed settings of the root sequence index associated with the network 131 as indicated by the communications 511) to the wireless network function 131 do not impact performance of the wireless network function 132 and corresponding parameters (as determined via mapping) such as root sequence index parameter, base station transmitter power parameter, antenna tilt parameter, associated with the second wireless network function 132, the execution function 505 associated with the communication management resource 140 transmits the communications 521 to the monitor function 121-4 associated with the wireless network function controller 121. The communications 521 in this example indicate that the wireless network function controller 121 can proceed with execution of the proposed changes because they are determined not to impact the corresponding parameters or corresponding settings associated with the root sequence index parameter, base station transmitter power parameter, antenna tilt parameter, currently implemented in the second wireless network function 132.

However, in a case where the proposed changes (such as adjustment to the antenna tilt associated with one or more wireless base stations as indicated by the communications 511) to the wireless network function 131 do impact performance of the wireless network function 132 and one or more corresponding parameter settings such as physical cell ID, root sequence index, base station transmitter power, and antenna tilt associated with the second wireless network function 132, the execution function 505 associated with the communication management resource 140 may transmit the communications 521 to the monitor function 121-4 associated with the wireless network function controller 121. The communications 521 in this example may indicate that the wireless network function controller 121 may not proceed with execution of the proposed changes because they are determined to impact one or more the corresponding parameters and corresponding settings such as physical cell ID, root sequence index, base station transmitter power, and antenna tilt associated with the second wireless network function 132. Note that the denial of implementing the proposed network settings by the communication management resource 140 may be because the wireless network function 132 is given higher priority than the first wireless network function 131.

Alternatively, the communication management resource 140 corresponding execution function 505 may determine that the wireless network function controller 121 may proceed with implementing the proposed configuration parameter settings because the wireless network function 131 may reside higher in priority in a hierarchy than the second wireless network function 132, even though the wireless network function 131 may be impacted by implementation of the settings as specified by the communications 511. In such an instance, the wireless network function 132 may be impacted by the proposed configuration parameter settings as proposed by the implementation function 121-3. However, the execution function 505 can be configured to transmit the communications 522 to the monitor function 122-4 indicating the changes that are going to be or should be implemented by the wireless network function controller 121. Thus, in response to receiving the proposed first modification as specified by the communications 511, the communication management resource 140 (such as execution function 505) can be configured to provide notification such as via communications 521 of the decision regarding implementation of the proposed first modification of wireless network function 131 to an operator or communication management resource of the second wireless network function 132.

Accordingly, the communication management resource 140 can be configured to receive a proposed first modification to a first configuration of a first wireless network function as indicated by the communications 511. As previously discussed, the first wireless network function 131 can be configured to provide overlapping wireless service with respect to a second wireless network function 132. The communication management resource 140 and corresponding one or more functions such as the relativity evaluation engine 441 identify a first parameter type associated with a first modification as specified by the proposed first modification in communications 511. Based on the first parameter type, as previously discussed, the communication management resource 140 corresponding relativity evaluation engine 441 determines an impact of the proposed first modification to one or more parameters and corresponding settings of the second wireless network function 132. The determination impact may include mapping the first parameter type as specified by the communications 511 to multiple different parameters associated with operation of the second wireless network function 132. Further, the relativity evaluation engine 441 or the execution function 505 determines whether the proposed changes to settings of the first wireless network function 131 impact corresponding settings associated with the second wireless network function based on relevant parameters as specified by the map information 150.

In accordance with further examples, note that the communication management resource 140 and corresponding functions can be configured to prevent implementation of the proposed first modification as specified by the communications 511 to first wireless network function 131 (such as by sending communications 521) in response to detecting that the impact is greater than a threshold level. In other words, if the impact of implementing the proposed configuration settings as specified by the communications 511 is greater than a threshold level to settings of the mapped parameters, then the communication management resource 140 prevents the wireless network function controller 121 from implementing those proposed configurations to the network 131.

Conversely, the communication management resource 140 can be configured to provide notification (such as via communications 521) to implement the proposed modifications as specified by the communications 511 in response to detecting that the impact to the second wireless network function is less than the threshold level.

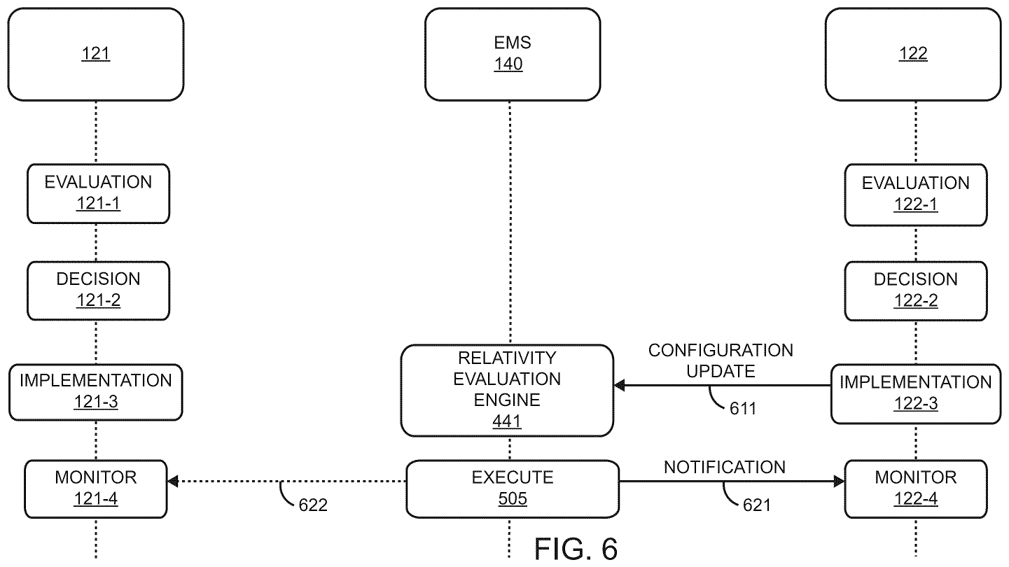

FIG. 6 is an example diagram illustrating execution of a relativity evaluation engine to manage implementation of proposed changes to a network as discussed herein.

In a similar manner as previously discussed, via the implementation function 122-3 associated with the wireless network function controller 122, the wireless network function controller 122 transmits communications 611 to the relativity evaluation engine 441 associated with the communication management resource for 140.

The communications 611 indicate proposed changes to one or more parameter settings of the wireless network function 132. In response to receiving the communications 611, the relativity evaluation engine 441 determines the corresponding set of parameters and corresponding settings associated with the wireless network function 131 that may be affected by the proposed changes to the second wireless network function 132.

Via communications 621 transmitted by the execution function 505 to the monitor function 122-4 associated with the wireless network function controller 122, the wireless network function controller 122 is notified of the decision of whether or not the wireless network function controller 122 is able to go forward with the proposed changes.

As further shown, and as previously discussed, the execution management function can be configured to transmit communications 622 to the monitor function 121-4 associated with the wireless network function controller 121. The communications 622 may indicate the implementation of the proposed changes by the wireless network function controller 122. Additionally, or alternatively, the communications may indicate that the wireless network function controller 121 needs to modify certain parameter settings of the wireless network function 131 (as determined from the map information 150 and implementation of the relativity evaluation engine 441) in order to allow the implementation of the proposed changes (as specified by the communications 611) to the wireless network function 132.

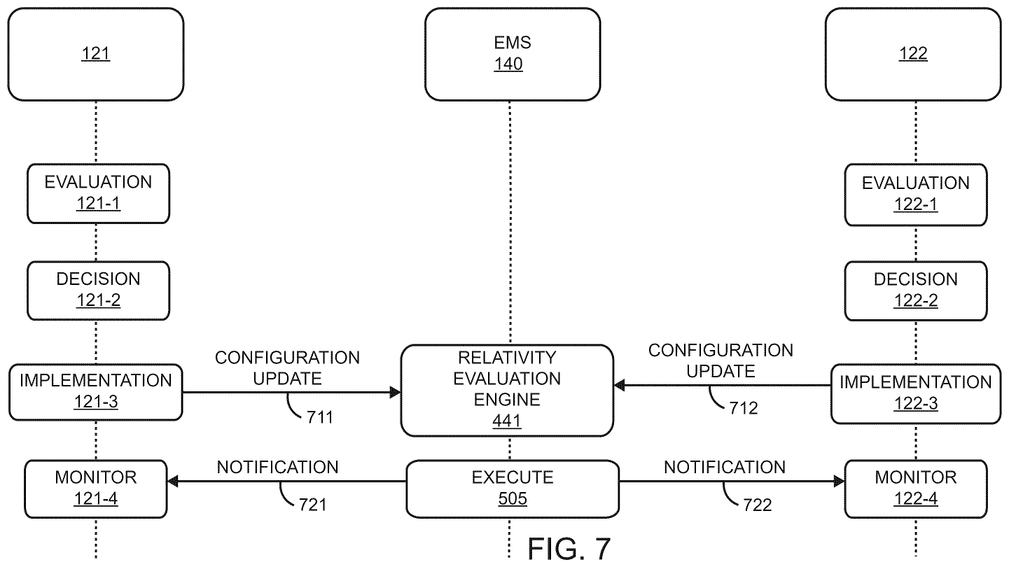

FIG. 7 is an example diagram illustrating execution of a relativity evaluation engine to manage proposed changes to multiple networks as discussed herein.

As another example of processing proposed parameter changes, assume that the wireless network function controller 121 (such as a D-SON) is updating a parameter such as antenna tilt of a respective wireless base station or network element in the wireless network function 131. This may impact the second wireless network function 132. However, the antenna tilt parameter change associated with the first wireless network function 131 is related (as indicated by the map information 150) to several other potential parameter changes which may impact the second wireless network function's 132 (such as C-SON network) proposed changes in a circumstance where changes in the second wireless network function include implementation changes to parameter such as physical cell id, root sequence index, transmit power, antenna tilt, etc.

In such an instance, the wireless network function controller 122 associated with the wireless network function 132 may either increase the wait period for implementation of those changes until after realizing the impact of changes made by the wireless network function controller 121.

Accordingly, the relativity table (such as parameter mapping information 150) provides translation of the impact of the changing one parameter in one or multiple nodes/elements in a first network and how it may impact a second network.

Yet further, as per the network needs, multiple applications may be scheduled to make network changes (or proposed changes) at different intervals. This architecture will allow more flexibility to make changes any time during the day or night by ensuring no relativity violation has been created within the network by any of the given applications. Also, the communication management resource 140 or other suitable entity such as the wireless network function controllers may wait for defined intervals for making such related changes in given base stations.

Thus, the architecture of C-SON where each node/elements/base stations will have the settings stored in a central repository (such as communication management resource 140) while the central processing layer will use those measurements to make defined decisions.

As further shown in FIG. 7, the communication management resource 140 and corresponding functions such as relativity evaluation engine 441 can be configured to receive proposed changes to each of the wireless network functions 131 and 132.

For example, via communications 711, relativity evaluation engine 441 receives first proposed configuration setting changes to one or more parameters associated with the wireless network function 131.

Via communications 712, the relativity evaluation engine receives second proposed configuration setting changes to one or more parameters associated with the wireless network function 132.

In a similar manner as previously discussed, the relativity evaluation engine 441 uses the map information 150 to determine relevant parameters and then determines the degree to which the first proposed configuration setting changes impacts the second wireless network function 132.

For example, via the first communications 711, the relativity evaluation engine 441 identifies a parameter type associated with a first modification as specified by the proposed first modification in the communications 711. Based on the parameter type, in a manner as previously discussed, the relativity evaluation engine 441 determines an impact of the proposed first modification to the second wireless network function 132.

The relativity evaluation engine 441 uses the map information 150 to determine the degree to which the second proposed configuration setting changes impacts the first wireless network function 131. The relativity evaluation engine 441 uses the map information 150 to determine the degree to which the second proposed configuration setting changes impacts the first wireless network function 131.

For example, via the communications 712, the relativity evaluation engine 441 identifies a parameter type associated with a second modification as specified by the proposed second setting modification in the communications 712. Based on the parameter type is specified by the communication 712, in a manner as previously discussed, the relativity evaluation engine 441 determines an impact of the proposed second modification to the first wireless network function 131.

The communications 721 from the communication management resource 140 to the monitor function 121-4 notify the wireless network function controller 121 whether the first proposed configuration settings can be implemented by the first wireless network function 131.

For example, the communication management resource 140 and corresponding functions may detect that the proposed first setting modifications (if implemented in the first wireless network function 131) would impact the second wireless network function 132 below a performance threshold level. In such an instance, the communication management resource 140 generates the communications 721 to notify the wireless network function controller 121 that the proposed first setting modifications may be implemented in the wireless network function 131.

Conversely, the communication management resource 140 and corresponding functions may detect that the proposed first setting modifications (if implemented in the first wireless network function 131) would impact the second wireless network function 132 above a performance threshold level. In such an instance, the communication management resource 140 generates the communications 721 to notify the wireless network function controller 121 that the proposed first setting modifications may not be implemented in the wireless network function 131.

The communication management resource 140 and corresponding functions may detect that the proposed second setting modifications (if implemented in the second wireless network function 132) would impact the first wireless network function 131 below a threshold level. In such an instance, the communication management resource 140 generates the communications 722 to notify the wireless network function controller 122 that the proposed second setting modifications as indicated by the communications 711 may be implemented in the wireless network function 131.

Conversely, the communication management resource 140 and corresponding functions may detect that the proposed second setting modifications (if implemented in the second wireless network function 132) would impact the first wireless network function 131 above a performance threshold level. In such an instance, the communication management resource 140 generates the communications 722 to notify the wireless network function controller 122 that the proposed second setting modifications may not be implemented in the wireless network function 131.

In further examples, the relativity evaluation engine 441 as part of the communication management resource 140 is a common layer such as communication management resource 140 between wireless network function controller 121 and wireless network function controller 122. In one example, as discussed herein, the proposed configuration changes are evaluated by the relativity evaluation engine 441 and the execution function 505 before they are implemented. Also, it is noted that execution of the proposed changes can be re-scheduled if there is a conflict such as improper impact to the other network.

For example:
Assume that one of the base stations/nodes in the wireless network function 131 suggests to make changes in PCI (physical cell ID of cell-A from 1 to 6) by the wireless network function 131 at 11:00 am. Independent of this decision to change the PCI associated with the wireless base station in the wireless network function 131, assume that the wireless network function controller 122 decides to make changes in PCI of cell B (from 3 to 6) in the wireless network function 131 at 11:30 am. Both cells are neighbors. The communication management resource 140 is notified of these proposed changes via receipt of communications 711 (indicating the change in physical cell identifier from 1 to 6) and communications 712 (indicating the change of the physical cell identifier from 3 to 6).

If the communication management resource 140 implements changes in PCI (1 to 6) of cell-A in the wireless network function 131, while a decision of making a change of cell-B (PCI from 3 to 6) in the wireless network function 132 was based on old PCI of cell-A (PCI 1) which means if the PCI of cell-A is changed to 6, decision of making change of PCI from 3 to 6 (cell B) becomes invalid. In other words, the communication management resource 140 is unable to allow the change of the PCI to 6 from both wireless network functions 131 because there would be a respective conflict otherwise. In such an instance, the execution function 505 associated with communication management resource 120 can be configured to transmit communications 721 to the wireless network function controller 121 indicating that the request for change of PCI to 6 as been denied, while communications from the communication management resource 140 may indicate that the change to the PCI to the value of 6 for wireless network function 132 is acceptable. Alternatively, the communication management resource 140 (via communications 721 and communications 722) notifies notified both the wireless network function controller 121 and the wireless network function controller 122 that the proposed changes have been denied such that neither of the wireless network functions is able to use the PCI value of 6.
Another instance where the wireless network function controller 121 implements a neighbor relation deletion from cell-A to cell-B while the wireless network function controller 122-SON has decided to make a change in cell individual offset (CIO). If the neighbor is deleted already, there is no point in making update in CIO (in fact there will be failure in command execution).

Accordingly, via the proposed architecture, in both of the above examples, the relativity evaluation engine 441 evaluates the execution of both the changes (even at the same time), and it will prioritize either based on time of arrival or severity of the change or any other defined criterion. It will help avoid making invalid changes, also it will help improve the efficiency of the system by not piling up related adjustments simultaneously.

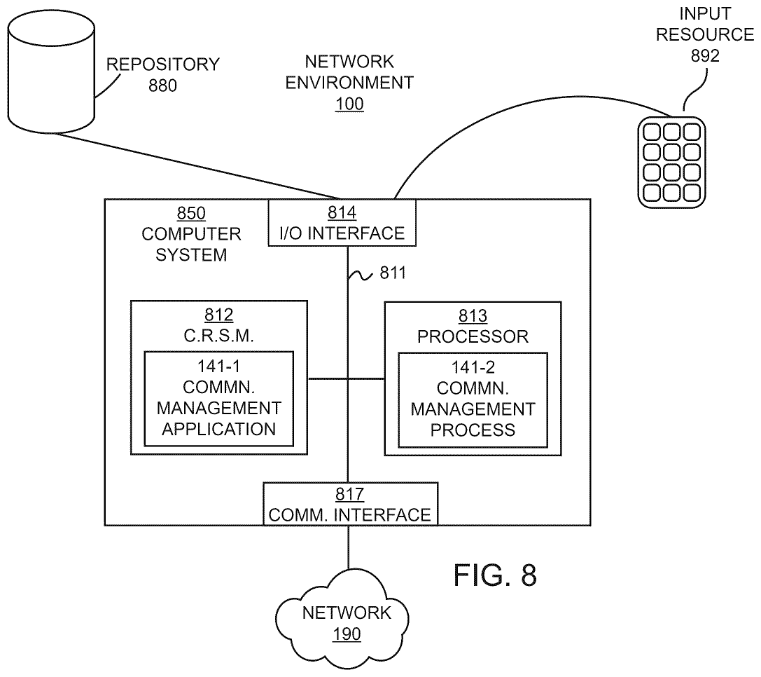

FIG. 8 is an example block diagram of a computer system for implementing any of the operations as discussed herein.

Note that any of the resources (such as communication management resource 140, relativity evaluation engine 441, wireless network function controller 121, wireless network function controller 122, base station BS11, base station BS12, . . . , base station BS19, base station BS21, base station BS22, etc.) as discussed herein can be configured to include computer processor hardware and/or corresponding executable instructions to carry out the different operations as discussed herein.

For example, as shown, computer system 850 of the present example includes interconnect 811 coupling computer readable storage media 812 such as a non-transitory type of media (which can be any suitable type of hardware storage medium in which digital information can be stored and or retrieved), a processor 813 (computer processor hardware), I/O interface 814, and a communications interface 817.

I/O interface(s) 814 supports connectivity to repository 880 and input resource 892.

Computer readable storage medium 812 can be any hardware storage device such as memory, optical storage, hard drive, floppy disk, etc. In one example, the computer readable storage medium 812 is computer readable storage hardware that stores instructions and/or data.

As shown, computer readable storage media 812 can be encoded with management application 140-1 (e.g., including instructions) in a respective wireless station to carry out any of the operations as discussed herein.

During operation of one example, processor 813 accesses computer readable storage media 812 via the use of interconnect 811 in order to launch, run, execute, interpret or otherwise perform the instructions in management application 140-1 stored on computer readable storage medium 812. Execution of the management application 140-1 (configuration management application) produces management process 140-2 (configuration management process) to carry out any of the operations and/or processes as discussed herein.

Those skilled in the art will understand that the computer system 850 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

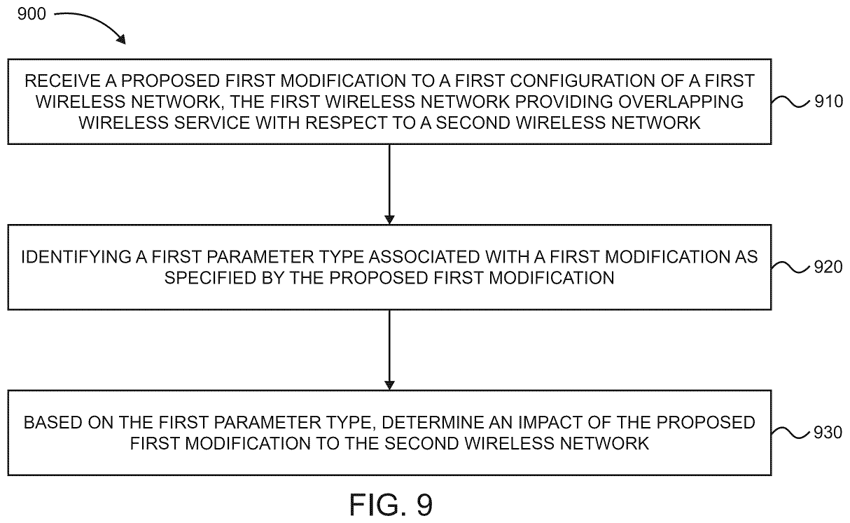

Functionality supported by the different resources will now be discussed via flowchart in FIG. 9. Note that the steps in the flowcharts below can be executed in any suitable order.

FIG. 9 is a flowchart 900 illustrating an example method according to examples herein. Note that there will be some overlap with respect to concepts as discussed above because the flowchart 900 captures the general ideas as previously presented.

In processing operation 910, the communication management resource 140 receives a proposed first modification to a first configuration of a first wireless network function 131. The first wireless network function 131 provides overlapping wireless service with respect to a second wireless network function 132.

In processing operation 920, the communication management resource 140 identifies a first parameter type associated with the proposed first modification.

In processing operation 930, based on the first parameter type, the communication management resource 140 determines an impact of the proposed first modification to the second wireless network function 132.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
receiving a proposed first modification to a first configuration of a first wireless network function, the first wireless network function providing overlapping wireless service with respect to a second wireless network function;
identifying a first parameter type associated with the proposed first modification; and
based on the first parameter type, determining an impact of the proposed first modification to the second wireless network function.

2. The method as in claim 1, wherein determining the impact of the proposed first modification to the second wireless network function includes:
mapping the first parameter type to multiple different parameters associated with operation of the second wireless network function.

3. The method as in claim 1, wherein determining the impact of the proposed first modification to the second wireless network function includes:
via parameter mapping information, mapping the first parameter type to a second parameter type associated with the second wireless network function, the second parameter type different than the first parameter type.

4. The method as in claim 1 further comprising:
producing a two-dimensional table including a first array of parameter types and a second array of parameter types;
wherein the first array of parameter types pertains to the first wireless network function; and
wherein the second array of parameter types pertains to the second wireless network function.

5. The method as in claim 4, wherein producing the two-dimensional table includes:
for each parameter type in the first array, marking at least one parameter type in the second array.

6. The method as in claim 1 further comprising:
in response to detecting that the impact is greater than a threshold, preventing implementation of the proposed first modification to configuration settings of the first wireless network function.

7. The method as in claim 1 further comprising:
in response to detecting that the impact is less than a threshold, providing notification to an operator of the first wireless network function to implement the proposed first modification to configuration settings of the first wireless network function.

8. The method as in claim 1 further comprising:
in response to receiving the proposed first modification, providing notification of the proposed first modification to an operator of the second wireless network function.

9. The method as in claim 1 further comprising:
receiving the proposed first modification to the configuration of the first wireless network function from a communication management resource, the communication management resource operative to manage implementation of the first wireless network function.

10. The method as in claim 1, wherein the first wireless network function is a D-SON (Distributed-Self Organizing Network); and
wherein the second wireless network function is a C-SON (Centralized-Self Organizing Network).

11. The method as in claim 1 further comprising:
receiving a proposed second modification to a second configuration of the second wireless network function;
identifying a second parameter type associated with the proposed second modification; and
based on the second parameter type, determining an impact of the proposed second modification to the first wireless network function.

12. A system comprising:
communication management hardware operative to:
receive a proposed first modification to a first configuration of a first wireless network function, the first wireless network function providing overlapping wireless service with respect to a second wireless network function;
identify a first parameter type associated with the proposed first modification; and
based on the first parameter type, determine an impact of the proposed first modification to the second wireless network function.

13. The system as in claim 12, wherein the communication management hardware is further operative to:
to determine the impact of the proposed first modification to the second wireless network function, map the first parameter type to multiple different parameters associated with operation of the second wireless network function.

14. The system as in claim 12, wherein the communication management hardware is further operative to:
to determine the impact of the proposed first modification to the second wireless network function, map the first parameter type to a second parameter type, the second parameter type different than the first parameter type.

15. The system as in claim 12, wherein the communication management hardware is further operative to:
produce a two-dimensional table including a first array of parameter types and a second array of parameter types;
wherein the first array of parameter types pertains to the first wireless network function; and
wherein the second array of parameter types pertains to the second wireless network function.

16. The system as in claim 15, wherein the communication management hardware is further operative to:
to produce the two-dimensional table, mark at least one parameter type in the second array for each parameter type in the first array.

17. The system as in claim 12, wherein the communication management hardware is further operative to:
in response to detecting that the impact is greater than a threshold, prevent implementation of the proposed first modification in the first wireless network function.

18. The system as in claim 12, wherein the communication management hardware is further operative to:
in response to detecting that the impact is less than a threshold, provide notification to an operator of the first wireless network function to implement the proposed first modification.

19. The system as in claim 12, wherein the communication management hardware is further operative to:
in response to receiving the proposed first modification, provide notification of the proposed first modification to an operator of the second wireless network function.

20. The system as in claim 12, wherein the communication management hardware is further operative to:
receive the proposed first modification to the first configuration of the first wireless network function from a communication management resource, the communication management resource operative to manage implementation of the first wireless network function.

21. The system as in claim 12, wherein the first wireless network function is a D-SON (Distributed-Self Organizing Network); and
wherein the second wireless network function is a C-SON (Centralized-Self Organizing Network).

22. The system as in claim 12, wherein the communication management hardware is further operative to:
receive a proposed second modification to a second configuration of the second wireless network function;
identify a second parameter type associated with the proposed second modification; and
based on the second parameter type, determine an impact of the proposed second modification to the first wireless network function.

23. Computer-readable storage hardware having instructions stored thereon, the instructions, when carried out by computer processor hardware, cause the computer processor hardware to:
receive a proposed first modification to a first configuration of a first wireless network function, the first wireless network function providing overlapping wireless service with respect to a second wireless network function;
identify a first parameter type associated the proposed first modification; and
based on the first parameter type, determine an impact of the proposed first modification to the second wireless network function.
